(19) United States
(12) Patent Application Publication
(10) Pub. No.: US 2014/0013610 A1
(43) Pub. Date: Jan. 16, 2014

(54) DRYING WAND

(71) Applicants: Mike Kilgore, Green Bay, WI (US); Alan P. Paal, New Franken, WI (US); Andy Lee Kirkpatrick, Green Bay, WI (US); David A. Parrott, Mason, OH (US); Brandon Leedy, Mason, OH (US); Robert J. Godfrey, Baraboo, WI (US)

(72) Inventors: Mike Kilgore, Green Bay, WI (US); Alan P. Paal, New Franken, WI (US); Andy Lee Kirkpatrick, Green Bay, WI (US); David A. Parrott, Mason, OH (US); Brandon Leedy, Mason, OH (US); Robert J. Godfrey, Baraboo, WI (US)

(73) Assignee: NUK USA LLC, Hackensack, NJ (US)

(21) Appl. No.: 13/547,337

(22) Filed: Jul. 12, 2012

(51) Int. Cl. F26B 19/00

(52) U.S. Cl. 34/95.1

(57) ABSTRACT

A drying wand for drying baby bottles and their component parts including a handle and top portion, the top portion having a plurality of petal shaped elements attached thereto in a radial configuration, the petal shaped elements being preferably formed from a microfiber material for more efficiently drying baby bottles and parts thereof. The handle further includes an ergonomic outer grip surface allowing for secure, comfortable gripping when the drying wand is in use.

### BACKGROUND OF THE INVENTION

The present invention relates generally to drying instruments and, more particularly, to a drying wand including a microfiber material which is specifically designed for convenient, ergonomic drying of baby bottles and other component parts associated therewith such as baby bottle nipples, collars and caps.

When handling and cleaning infant feeding equipment, the hygienic cleansing of baby bottles, baby bottle nipples and other component parts is of critical importance. Ideally, between each use, bottles and nipples should be thoroughly scrubbed and then sterilized for use. Proper cleaning and scrubbing after use is particularly important so as to get rid of and clear any remaining food or liquid particles such as fatty liquids, or liquids having suspended solids therein such as formula, cereal, or other infant feeding products. It is important to remove all such remaining food or liquid particles because these types of remaining particles and/or residue may serve as a breeding ground for bacteria, potentially causing illness or infection.

Brushes designed specifically for cleaning bottles are often found in households having young children as well as in a variety of caregiving facilities such as daycares and nurseries. Oftentimes, such brushes are one of many objects purchased to assist in maintaining a clean eating environment for babies. While there are a wide variety of instruments/devices available to clean and sterilize bottles, once the bottles have been washed, they are usually left out to air dry. Furthermore, the areas where bottles are left to dry are frequently cluttered with a multitude of other items including, but not limited to, bottle brushes, nipple brushes, collars, caps, bibs, towels, drying racks, formula containers, sterilizing equipment, pacifiers, sippy cups, eating utensils, and other similar items. Leaving baby bottles and their component parts sitting out on countertops and other areas to dry not only causes excessive clutter, but also unnecessarily exposes the damp surfaces of the bottle to germs, debris, dust and other contaminants. Consequently, a device designed specifically to quickly and efficiently dry baby bottles and their component parts would be extremely useful in order to both minimize clutter and to provide a dry, sanitary baby bottle for use by infants.

### SUMMARY OF THE INVENTION

The present invention is directed to a drying wand which provides an improved configuration that is compact, convenient, and ergonomic and is constructed to provide for quick and efficient drying of baby bottles and other component parts of baby bottles such as baby bottle nipples, collars, caps and the like. The present drying wand includes a top portion and a handle. The handle may include an ergonomic outer grip surface allowing for secure, comfortable gripping when the drying wand is in use. The handle may further include a base portion having a substantially flat bottom surface which provides for upright storage when the drying wand is not in use. This enables the top portion of the drying wand to stay dry and it also protects the top portion from contacting germ-laden surfaces.

The top portion may include a plurality of petal shaped drying elements attached to the outer surface of the top portion in a radial configuration. Each of the petal shaped elements may be fixedly attached to the outer surface of the top portion. In one embodiment, an edge portion of each petal shaped element engages a respective channel and the petal shaped elements are retained within the respective channels by a cap. In one embodiment, the petal shaped elements may be substantially hourglass shaped and preferably sized and shaped to facilitate drying of baby bottles and their component parts.

In alternative embodiments, the petal shaped drying elements and/or the cap may be removably secured to the top portion to facilitate the removal and replacement of the drying elements.

In one embodiment, the petal shaped drying elements may be formed from a microfiber material, or any suitable synthetic fiber, that has one or more of the desired characteristics, namely, softness, durability, shape retention, absorption and/or wicking abilities. Constructing the petal shaped drying elements formed from a microfiber material is advantageous because this type of material has the capacity to absorb a significant volume of liquid and the material is not abrasive or hard enough to scratch or otherwise damage a surface such as a bottle surface when it comes into contact with such surface. The fine nature of the fibers also provides for the removal of dust, debris and/or particles from completely dry surfaces.

Specific advantages and features of the present assembly will be apparent from the accompanying drawings and the description of several illustrative embodiments of the present invention.

### DESCRIPTION OF THE DRAWINGS

FIG. 1 illustrates a perspective view of one embodiment of a drying wand constructed in accordance with the teachings of the present invention.

FIG. 2 is a front elevational view of the drying wand of FIG. 1.

FIG. 3 is a side elevational view of the drying wand of FIG. 1.

FIG. 4 is a top plan view of the drying wand of FIG. 1.

FIG. 5 is an exploded view of the drying wand of FIG. 1.

It should be understood that the present drawings are not necessarily to scale and that the embodiments disclosed herein are sometimes illustrated by fragmentary views. In certain instances, details which are not necessary for an understanding of the present invention or which render other details difficult to perceive may have been omitted. It should also be understood that the invention is not necessarily limited to the particular embodiments illustrated herein. Like numbers utilized throughout the various figures designate like or similar parts or structure.

### DETAILED DESCRIPTION

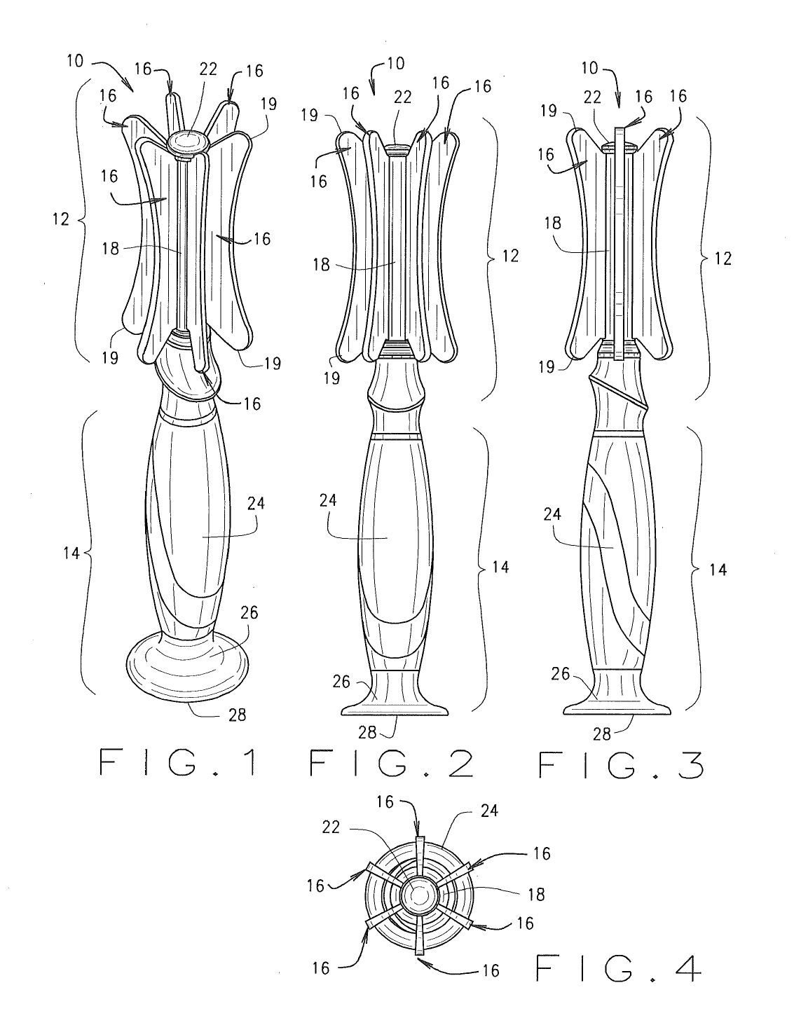

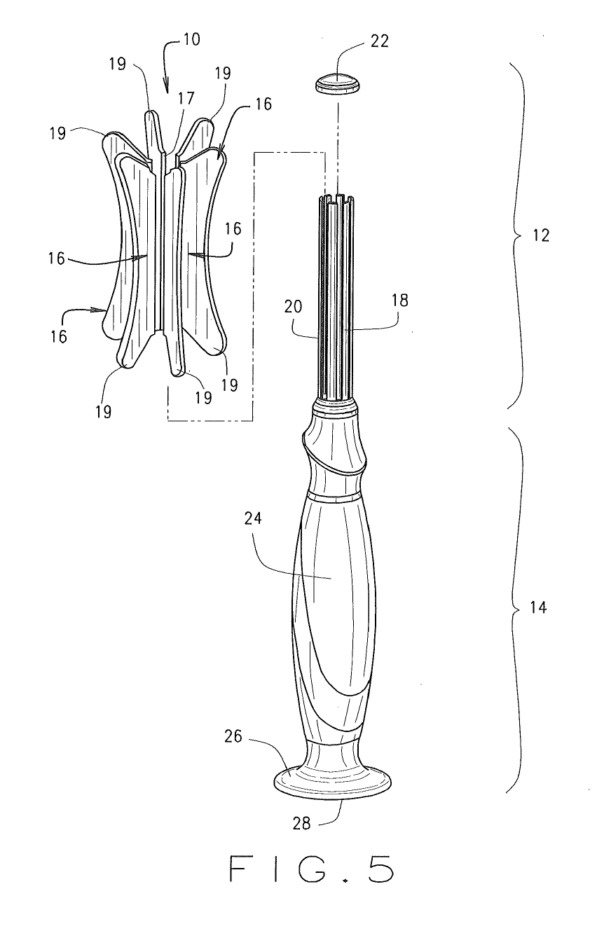

Referring now to the drawings more particularly by reference numbers, FIGS. 1-5 illustrate one embodiment of the drying wand 10 constructed in accordance with the teachings of the present invention. The present drying wand 10 is configured for drying baby bottles including, but not limited to, the component parts of baby bottles such as baby bottle nipples, collars, caps and other items. The wand 10 may include a top portion 12 and a handle 14. The top portion 12 may include a plurality of petal shaped drying elements 16 attached to the outer surface 18 of the top portion 12 in a radial configuration. Each of the petal shaped elements 16 may be fixedly attached to the outer surface 18 of the top portion 12 by any suitable means including engaging an edge portion of each petal shaped element 16 with a respective channel 20 (FIG. 5). In one embodiment, the drying elements 16 form the drying portion of the wand 10 and can be secured within the channels 20 by any suitable means such as by adhesions. In another embodiment, an edge portion of each petal shaped element 16 is slidably engaged with a corresponding channel 20 and held in position on the top of top portion 12 by the cap 22. The cap 22 may be secured to the top face of the outer surface 18 by sonic welding or any other process of permanent attachment.

In alternative embodiments, the petal shaped elements 16 each include an edge portion 17 which is slidably inserted into a corresponding channel 20 and the cap 22 may be removably secured to the top portion 12 by any suitable means such that when the cap 22 is removed, any one of the drying elements 16 may be removed and replaced when worn. This allows a user the opportunity to remove and replace the elements 16 if necessary. The removal of cap 22 facilitates the removal and replacement of the petal shaped elements 16.

It is recognized and anticipated that at least one of the plurality of petal shaped drying elements may be removably attachable to the top portion 12 whereas other petal shaped drying elements may be permanently affixed thereto. Any combination of removably attached drying elements 16 and permanently attached drying elements 16 can be configured in any particular embodiment.

The petal shaped elements 16 may be fashioned from any suitable non-scratch material, including, but not limited to, natural sponge, synthetic sponge, cellulose, foamed plastic polymers, low-density polyether, PVA, polyester, soft fabric, mesh and the like. In one embodiment, the petal shaped elements 16 may be fashioned from a microfiber material which may have one or more of the desired characteristics of softness, durability, shape retention, absorption and/or wicking abilities. Constructing the petal shaped elements 16 from a microfiber material is extremely advantageous because it has the capacity to absorb a significant volume of liquid and the material is not abrasive or hard enough to scratch or otherwise damage a surface of the bottle, or any other surface, when it comes into contact with such surface. The fine nature of the fibers comprising the microfiber material also provide for the removal of dust, debris and/or particles from completely dry surfaces. Microfiber materials greatly speed up the drying process and provide for a more efficient and effective drying process. Regardless of the material used, the drying elements 16 must be formed from a material adapted for drying baby bottles and parts thereof.

The petals 16 may be substantially hourglass shaped and preferably sized to facilitate the drying of baby bottles and their component parts. The hourglass shape is important because its shape is conducive to drying baby bottles and such shape includes top portions 19 which are specially shaped to reach inside hard to reach corners of the bottle. This configuration maximizes the points of contact of the drying elements 16 within a baby bottle. It is also understood that the petal shaped elements 16 may be fashioned into other shapes, as desired, to accommodate various alternative designs of the wand 10 without departing from the teachings and practice of the present invention.

The handle 14 may further include an ergonomic outer grip surface 24 formed from a substantially resilient material such as, but not limited to, organic polymers, elastomeric material, thermoplastic, thermosetting polymer, polycarbonate, polyethylene, polypropylene, polystyrene, polyvinyl chloride, silicone, polytetrafluoroethylene and the like. Because the top portion 12 is fixedly mounted to the handle 14, the ergonomic outer grip surface 24 allows for secure, comfortable gripping when the wand 10 is in use. The handle 14 may further include a base portion 26 having a substantially flat bottom face or surface 28 which provides for upright storage when the wand 10 is not in use thereby allowing the top portion 12 to stay dry and protecting the top portion 12 from contacting germ-laden surfaces.

Thus, there has been shown and described several embodiments of a novel drying wand. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A drying wand comprising:
a handle;
a top portion; and
a plurality of petal shaped elements attached to the top portion in a radial configuration;
wherein the petal shaped elements are formed from a material adapted for drying baby bottles and parts thereof.

2. The drying wand according to claim 1 wherein the petal shaped elements are formed from a non-scratch material.

3. The drying wand according to claim 1 wherein the petal shaped elements are formed from a synthetic sponge-like material.

4. The drying wand according to claim 1 wherein the petal shaped elements are substantially hourglass shaped.

5. The drying wand according to claim 1 wherein the petal shaped elements are formed from a microfiber material.

6. The drying wand according to claim 1 wherein the handle includes a resilient ergonomic surface.

7. The drying wand according to claim 1 wherein the handle includes a base portion for positioning the wand upright on a substantially flat surface.

8. A drying wand comprising:
a handle;
a top portion; and
a plurality of petal shaped elements attached to the top portion in a radial configuration, the petal shaped elements being substantially hourglass in shape and being formed from a material adapted for drying baby bottles and parts thereof.

9. The drying wand according to claim 8 wherein the petal shaped elements are formed from a non-scratch material.

10. The drying wand according to claim 8 wherein the petal shaped elements are formed from a synthetic sponge-like material.

11. The drying wand according to claim 8 wherein the petal shaped elements are formed from a microfiber material.

12. The drying wand according to claim 8 wherein the handle includes a resilient ergonomic surface.

13. The drying wand according to claim 8, wherein the handle includes a base portion for positioning the wand upright on a substantially flat surface.

14. A drying wand comprising:
a handle;
a top portion; and
a plurality of petal shaped elements attached to the top portion in a radial configuration, the petal shaped elements being substantially hourglass in shape and being formed of a microfiber material.
